(19) United States
(12) Patent Application Publication
(10) Pub. No.: US 2025/0219091 A1
(43) Pub. Date: Jul. 3, 2025

(54) ALL-SOLID-STATE BATTERY AND METHOD FOR PRODUCING SAME

(71) Applicant: Panasonic Intellectual Property Management Co., Ltd., Osaka (JP)

(72) Inventor: SHUZO TSUCHIDA, Nara (JP)

(21) Appl. No.: 19/053,796

(22) Filed: Feb. 14, 2025

Related U.S. Application Data
(63) Continuation of application No. PCT/JP2023/022809, filed on Jun. 20, 2023.

(30) Foreign Application Priority Data
Aug. 30, 2022 (JP) 2022-137158

(51) Int. Cl. H01M 4/62; H01M 4/02; H01M 10/0562

(52) U.S. Cl. CPC H01M 4/625; H01M 10/0562; H01M 2004/021; H01M 2004/028

(57) ABSTRACT

All-solid-state battery (100) includes positive electrode current collector (7), positive electrode layer (20) including positive electrode active materials (3), solid electrolyte (1), a solid electrolyte (2), and conductive fiber (9), solid electrolyte layer (40) including solid electrolyte (6), negative electrode layer (30) including negative electrode active material (4) and solid electrolyte (5), and negative electrode current collector (8), all of which are stacked in this order. Positive electrode layer (20) includes a solvent component of 50 ppm or less. Positive electrode layer (20) includes plate-shaped compressed body (11) between positive electrode active materials (3), the plate-shaped compressed body including at least a part of solid electrolyte (1) and at least a part of conductive fiber (9). Compressed body (11) has a first maximum length in a first direction orthogonal to a thickness direction of compressed body (11) and a second maximum length in a second direction orthogonal to the thickness direction of compressed body (11) and the first direction, at least one of the first maximum length and the second maximum length being 5 times or more and 50 times or less an average thickness of compressed body (11).

### TECHNICAL FIELD

The present disclosure relates to an all-solid-state battery and a method of manufacturing the same, and particularly relates to an all-solid-state battery using a positive electrode layer, a negative electrode layer, and a solid electrolyte layer and a method of manufacturing the same.

### BACKGROUND ART

In recent years, electronic devices such as personal computers and mobile phones have become more light-weight and cordless, and development of repeatedly usable secondary batteries has been needed. Examples of secondary batteries include a nickel cadmium battery, a nickel hydrogen battery, a lead storage battery, and a lithium ion battery. Among these secondary batteries, the lithium ion battery has features such as light weight, high voltage, and high energy density, and has attracted attention.

Development of secondary batteries having high battery capacity is emphasized also in the field of automobiles such as electric vehicles and hybrid vehicles, and the demand for lithium ion batteries has shown an increasing trend.

The lithium ion battery includes a positive electrode layer, a negative electrode layer, and an electrolyte disposed therebetween. As an electrolyte, for example, an electrolytic solution that is an organic solvent in which a supporting electrolyte such as lithium hexafluorophosphate is dissolved or a solid electrolyte is used. A lithium ion battery that is currently widely available includes an electrolytic solution containing organic solvent and is thus flammable. So that a material, a structure, and a system for securing safety of the lithium ion battery are necessary. On the other hand, by using a non-flammable solid electrolyte as the electrolyte, it is expected that the above-described material, structure, and system can be simplified, and it is considered that an increase in energy density, a reduction in manufacturing cost, and an improvement in productivity can be achieved. Hereinafter, a battery using a solid electrolyte such as a lithium ion battery using a solid electrolyte that conducts lithium (Li) ions will be referred to as an “all-solid-state battery”.

The solid electrolyte can be broadly categorized into an organic solid electrolyte and an inorganic solid electrolyte. The organic solid electrolyte has a lithium ion conductivity of about 10⁻⁶ S/cm at 25° C., which is extremely lower than a lithium ion conductivity of the electrolytic solution of about 10⁻³ S/cm. Thus, it is difficult to operate an all-solid-state battery using the organic solid electrolyte in an environment of 25° C. An oxide-based solid electrolyte, a sulfide-based solid electrolyte, and a halide-based solid electrolyte are generally used as the inorganic solid electrolyte. The lithium ion conductivities thereof are about 10⁻⁴ to 10⁻³ S/cm, and the lithium ion conductivities are relatively high. Since the sulfide-based solid electrolyte and the halide-based solid electrolyte have small grain boundary resistance, the sulfide-based solid electrolyte and the halide-based solid electrolyte are characterized in that good characteristics can be obtained only by compression molding a powder without using a sintering process. In recent years, for the development of all-solid-state batteries having further larger size and higher capacity, research on coating type all-solid-state batteries capable of increasing the size using a sulfide-based solid electrolyte has been actively conducted.

The coating type all-solid-state battery includes, for example, a positive electrode layer formed on a current collector made of a metal foil and containing a positive electrode active material, a solid electrolyte, and a binder, a negative electrode layer formed on a current collector made of a metal foil and containing a negative electrode active material, a solid electrolyte, and a binder, and a solid electrolyte layer disposed between the positive electrode layer and the negative electrode layer and containing a solid electrolyte and a binder. Hereinafter, the positive electrode active material and the negative electrode active material may be collectively referred to as an “active material”.

Furthermore, for the purpose of improving the performance and reliability of the all-solid-state battery, studies have been made to add various additives. For example, PTL 1 discloses an all-solid-state battery using a coating slurry obtained by mixing an active material, a solid electrolyte layer, and a linear structure with a solvent when forming a positive electrode layer or a negative electrode layer.

Moreover, in a method of manufacturing a positive electrode layer or a negative electrode layer, when a solvent is used, there is a concern that the active material and the solid electrolyte are deteriorated by the solvent, and a method of manufacturing an all-solid-state battery in a dry manner without using a solvent has also attracted attention. For example, PTL 2 discloses a method of forming a positive electrode layer or a negative electrode layer by pressurizing and pressing a mixture obtained by mixing an active material and a solid electrolyte in a dry manner as a manufacturing method using no solvent.

### CITATION LIST

### Patent Literature

PTL 1: Japanese Translation of PCT International Application Publication No. 2020-507893

PTL 2: Unexamined Japanese Patent Publication No. H08-138724

### SUMMARY OF THE INVENTION

An all-solid-state battery according to an aspect of the present disclosure includes a positive electrode current collector, a positive electrode layer including positive electrode active materials, a first solid electrolyte, a second solid electrolyte, and a conductive fiber, a solid electrolyte layer including a fourth solid electrolyte, a negative electrode layer including a negative electrode active material and a third solid electrolyte, and a negative electrode current collector, all of which are stacked in this order, in which the positive electrode layer includes a solvent component of 50 ppm or less, the positive electrode layer includes a plate-shaped compressed body between the positive electrode active materials, the plate-shaped compressed body including at least a part of the first solid electrolyte and at least a part of the conductive fiber, and the compressed body has a first maximum length in a first direction orthogonal to a thickness direction of the compressed body and a second maximum length in a second direction orthogonal to the thickness direction of the compressed body and the first direction, at least one of the first maximum length and the second maximum length being 5 times or more and 50 times or less an average thickness of the compressed body.

A method of manufacturing an all-solid-state battery according to an aspect of the present disclosure is a method of manufacturing an all-solid-state battery including a positive electrode current collector, a positive electrode layer including a positive electrode active material, a first solid electrolyte, a second solid electrolyte, and a conductive fiber, a solid electrolyte layer including a fourth solid electrolyte, a negative electrode layer including a negative electrode active material and a third solid electrolyte, and a negative electrode current collector, all of which are stacked in this order, the method including a step of manufacturing the positive electrode layer, in which the step of manufacturing the positive electrode layer includes: a step of mixing the first solid electrolyte and the conductive fiber in a dry manner and forming a mixture including a compressed body including at least a part of the first solid electrolyte and an aggregate containing at least a part of the conductive fiber; and a step of mixing the positive electrode active material and the second solid electrolyte with the formed mixture.

### BRIEF DESCRIPTION OF THE DRAWINGS

FIG. 1 is a schematic view illustrating a cross section of an all-solid-state battery according to an exemplary embodiment.

FIG. 2 is a schematic cross-sectional view for explaining a method of manufacturing the all-solid-state battery in the exemplary embodiment.

FIG. 3 is a flowchart illustrating a method of manufacturing a positive electrode mixture in the exemplary embodiment.

FIG. 4 is a flowchart illustrating a method of manufacturing a positive electrode mixture in Comparative Example.

FIG. 5 is a schematic view for explaining changes in states of a positive electrode active material, a solid electrolyte, and a conductive fiber in Comparative Example.

FIG. 6 is a schematic view for explaining changes in states of a positive electrode active material, a solid electrolyte, and conductive fibers in the exemplary embodiment.

FIG. 7 is a schematic perspective view for explaining behavior of a material in a process of forming a compressed body in the exemplary embodiment.

FIG. 8 is a schematic perspective view for explaining behavior of a material in a process of manufacturing a positive electrode mixture and a positive electrode layer in the exemplary embodiment.

FIG. 9 is a table illustrating results of evaluating battery characteristics of all-solid-state batteries in Example 1 and Comparative Example 1.

### DESCRIPTION OF EMBODIMENT

### How One Exemplary Embodiment of the Present Disclosure has Been Obtained

The present inventor has found that the following problems occur in the conventional all-solid-state battery described in the “BACKGROUND ART”.

In one of the methods described in PTL 1, a positive electrode layer is formed by forming a mixture obtained by mixing positive electrode active material particles, solid electrolyte particles, and a linear structure of a carbon material (hereinafter, it is referred to as a conductive fiber) using a solvent into a film. However, in a case where this method is applied to a method of mixing a mixture without using a solvent, the following two problems occur.

The first problem is that an ion conduction path is not secured by the conductive fiber. Specifically, in general, conductive fibers are formed by aggregation of fine fibers, and often exist as conductive fiber aggregates. Therefore, it is common to unravel the conductive fiber aggregate using a dispersant or the like in a solvent to disperse the unraveled conductive fibers. However, in a case where a mixture is manufactured in a dry manner without using a solvent or the like, the conductive fiber aggregate remains. Therefore, the conductive fiber aggregate causes a large mass in which the solid electrolyte and the active material adhere to the periphery of the conductive fiber aggregate in the mixture. That is, in the positive electrode layer or the negative electrode layer constituting the all-solid-state battery, a portion where the solid electrolyte does not exist is generated inside the conductive fiber aggregate in which the conductive fibers are aggregated. As a result, although an electron conduction path is secured by the conductive fiber, an ion conduction path is not secured at a portion where the solid electrolyte does not exist in the conductive fiber aggregate, and thus a problem that battery performance is deteriorated occurs.

The second problem is that, for example, when the positive electrode layer is formed by leveling the positive electrode mixture in a powder state on a plane with a squeegee or the like without using a solvent, the positive electrode layer is hardly formed uniformly due to a large mass formed by adhering the solid electrolyte and the active material around the conductive fiber aggregate described above, so that a stable positive electrode layer cannot be formed.

Therefore, in view of the above problems, the present disclosure provides an all-solid-state battery and the like that can suppress a decrease in a battery capacity even in a case where a positive electrode layer including conductive fibers is formed without using a solvent. Furthermore, in the all-solid-state battery or the like according to the present disclosure, a stable positive electrode layer can be formed.

### Summary of the Present Disclosure

Hereinafter, an example of an all-solid-state battery and a method of manufacturing the all-solid-state battery according to the present disclosure will be described.

An all-solid-state battery according to a first aspect of the present disclosure including a positive electrode current collector, a positive electrode layer including positive electrode active materials, a first solid electrolyte, a second solid electrolyte, and a conductive fiber, a solid electrolyte layer including a fourth solid electrolyte, a negative electrode layer including a negative electrode active material and a third solid electrolyte, and a negative electrode current collector, all of which are stacked in this order, in which the positive electrode layer includes a solvent component of 50 ppm or less, the positive electrode layer includes a plate-shaped compressed body between the positive electrode active materials, the plate-shaped compressed body including at least a part of the first solid electrolyte and at least a part of the conductive fiber, and the compressed body has a first maximum length in a first direction orthogonal to a thickness direction of the compressed body and a second maximum length in a second direction orthogonal to the thickness direction of the compressed body and the first direction, at least one of the first maximum length and the second maximum length being 5 times or more and 50 times or less an average thickness of the compressed body.

As a result, even in the positive electrode layer including the conductive fiber in which a conductive fiber aggregate is highly likely to remain because a solvent is not substantially contained, the compressed body including at least a part of the first solid electrolyte and at least a part of the conductive fiber serves as an ion conduction path between the positive electrode active materials, and even in a case where the conductive fiber aggregate remains, inhibition of ion conduction by the conductive fiber aggregate can be suppressed. Furthermore, since at least one of the first maximum length and the second maximum length is 5 times or more and 50 times or less the average thickness of the compressed body, it is possible to achieve both suppression of a decrease in ion conductivity in the positive electrode layer and suppression of a decrease in filling property of the positive electrode active materials in the positive electrode layer. Therefore, it is possible to suppress a decrease in a battery capacity of the all-solid-state battery according to the present aspect.

Furthermore, an all-solid-state battery according to a second aspect of the present disclosure is, for example, the all-solid-state battery according to the first aspect, in which the first maximum length and the second maximum length are 5 times or more and 50 times or less the average thickness of the compressed body.

This makes it possible to suppress a decrease in ion conductivity between the positive electrode active materials.

Furthermore, an all-solid-state battery according to a third aspect and a fourth aspect of the present disclosure is, for example, the all-solid-state battery according to the first aspect or the second aspect, in which at least one of the first maximum length and the second maximum length is twice or more an average particle size of each of the positive electrode active materials.

This makes it possible to suppress a decrease in a battery capacity even in a case where the conductive fiber contains a large conductive fiber aggregate.

Furthermore, an all-solid-state battery according to a fifth aspect of the present disclosure is, for example, the all-solid-state battery according to any one of the first to fourth aspects, in which the conductive fiber included in the compressed body includes a portion having a fiber diameter of 50 nm or more.

This makes it possible to improve ion conductivity in the positive electrode layer.

Furthermore, an all-solid-state battery according to a sixth aspect of the present disclosure is, for example, the all-solid-state battery according to any one of the first to fifth aspects, in which the average thickness of the compressed body is in a range of 2 times or more and 50 times or less an average fiber diameter of the conductive fiber included in the compressed body.

This makes it possible to improve ion conductivity in the positive electrode layer.

Furthermore, an all-solid-state battery according to a seventh aspect of the present disclosure is, for example, the all-solid-state battery according to any one of the first to sixth aspects, in which the conductive fiber includes a carbon-based material.

As a result, deterioration or the like hardly occurs during use of the battery, and battery performance can be stabilized.

Furthermore, an all-solid-state battery according to an eighth aspect of the present disclosure is, for example, the all-solid-state battery according to any one of the first to seventh aspects, in which in the positive electrode layer, the first solid electrolyte and the second solid electrolyte has a total content having a ratio of 15 vol % or more and 30 vol % or less with respect to a total content of the positive electrode active materials, the first solid electrolyte, and the second solid electrolyte.

As a result, both an ion conduction path and an electron conduction path in the positive electrode layer are easily secured.

Furthermore, an all-solid-state battery according to a ninth aspect of the present disclosure is, for example, the all-solid-state battery according to any one of the first to eighth aspects, in which in the positive electrode layer, the conductive fiber has a content having a ratio of 0.1 vol % or more and 5 vol % or less with respect to a total content of the positive electrode active materials, the first solid electrolyte, and the second solid electrolyte.

As a result, both an ion conduction path and an electron conduction path in the positive electrode layer are easily secured.

Furthermore, a method of manufacturing an all-solid-state battery according to a tenth aspect of the present disclosure is a method of manufacturing an all-solid-state battery including a positive electrode current collector, a positive electrode layer including a positive electrode active material, a first solid electrolyte, a second solid electrolyte, and a conductive fiber, a solid electrolyte layer including a fourth solid electrolyte, a negative electrode layer including a negative electrode active material and a third solid electrolyte, and a negative electrode current collector, all of which are stacked in this order, the method including a step of manufacturing the positive electrode layer, in which the step of manufacturing the positive electrode layer includes: a step of mixing the first solid electrolyte and the conductive fiber in a dry manner and forming a mixture including a compressed body including at least a part of the first solid electrolyte and an aggregate containing at least a part of the conductive fiber; and a step of mixing the positive electrode active material and the second solid electrolyte with the formed mixture.

As a result, even in a case where the conductive fiber is mixed in a dry manner in the manufacturing of the positive electrode layer, the compressed body including the conductive fiber aggregate is formed, so that the compressed body serves as an ion conduction path between the positive electrode active materials, and inhibition of ion conduction by the conductive fiber aggregate can be suppressed. Therefore, it is possible to suppress a decrease in a battery capacity of the all-solid-state battery according to the present aspect.

Furthermore, a method of manufacturing an all-solid-state battery according to an eleventh aspect of the present disclosure is, for example, the method of manufacturing an all-solid-state battery according to the tenth aspect, in which in the step of forming a mixture, the first solid electrolyte has a volume of 3 times or more and 10 times or less a volume of the conductive fiber.

This facilitates stable formation of the compressed body.

Hereinafter, an all-solid-state battery according to an exemplary embodiment will be described in detail. Note that the exemplary embodiments described below illustrate comprehensive or specific examples. Numerical values, shapes, materials, constituent elements, arrangements and connection modes of the constituent elements, steps, processes and the like illustrated in the following exemplary embodiments are merely examples, and are not intended to limit the present disclosure. Furthermore, among the constituent elements in the following exemplary embodiments, constituent elements not recited in the independent claims are described as arbitrary constituent elements.

Furthermore, in the present specification, terms indicating a relationship between elements such as parallel and orthogonal, terms indicating a shape of an element such as a rectangle, and numerical ranges are not expressions representing only a strict meaning, but are expressions meaning to include a substantially equivalent range, for example, a difference of about several %.

Furthermore, the drawings are schematic views including emphasis, omission, and proportional adjustment as required to illustrate the present disclosure. These drawings are not strictly illustrated and may include shape, positional relationship, and percentage that differ from the actual ones. In the drawings, substantially identical configurations are denoted by the same reference mark, and duplicate description may be omitted or simplified.

Furthermore, in the present specification, terms “upper” and “lower” used for a configuration of the all-solid-state battery do not refer to an upper direction (vertically upward) and a lower direction (vertically downward) in absolute space recognition, but are used as terms defined by a relative positional relationship based on the stacking order in a stacking configuration.

Furthermore, in the present specification, a cross-sectional view illustrates a cross section taken at the central portion of the all-solid-state battery along a stacking direction. Furthermore, in the present specification, the stacking direction is the same as the thickness direction of the layers of the all-solid-state battery and the normal direction of the principal surface of each layer of the all-solid-state battery.

Furthermore, in the present specification, ordinal numbers such as “first” and “second” do not mean the number or order of constituent elements unless otherwise specified, and are used for the purpose of avoiding confusion and distinguishing the same kind of constituent elements.

### Exemplary Embodiment

### <Configuration>

### A. All-Solid-State Battery

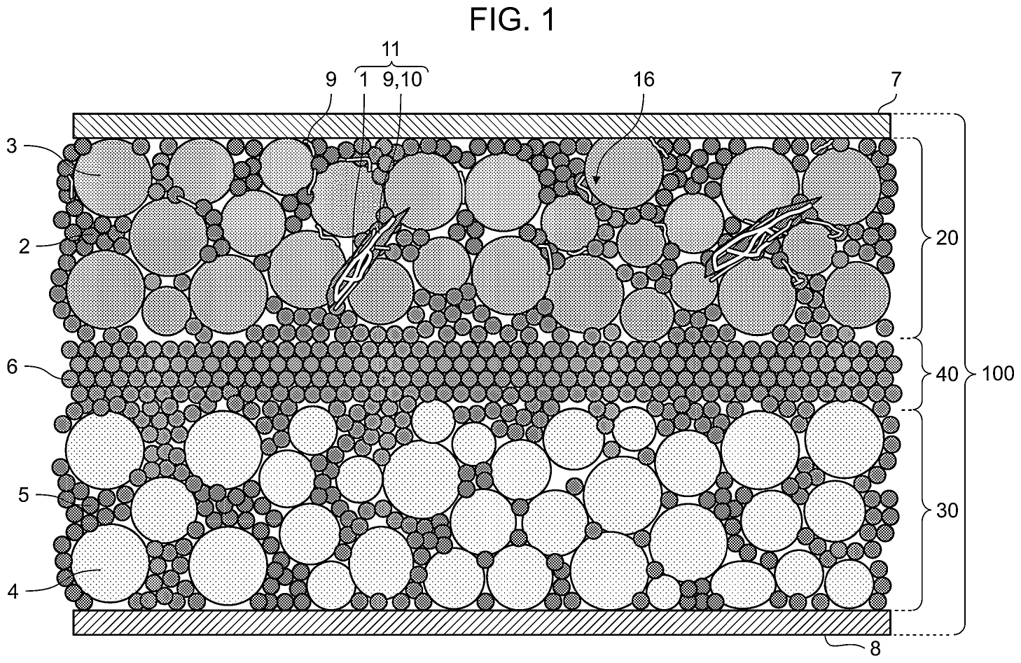

An outline of an all-solid-state battery according to a present exemplary embodiment will be described with reference to FIG. 1. FIG. 1 is a schematic view illustrating a cross section of all-solid-state battery 100 according to the present exemplary embodiment. All-solid-state battery 100 in the present exemplary embodiment includes positive electrode current collector 7, negative electrode current collector 8 facing positive electrode current collector 7, positive electrode layer 20 formed on a surface of positive electrode current collector 7 close to negative electrode current collector 8 and including positive electrode active material 3, solid electrolyte 1, solid electrolyte 2, and conductive fibers 9, negative electrode layer 30 formed on a surface of negative electrode current collector 8 close to positive electrode current collector 7 and including negative electrode active material 4 and solid electrolyte 5, and solid electrolyte layer 40 disposed between positive electrode layer 20 and negative electrode layer 30 and including solid electrolyte 6. That is, all-solid-state battery 100 has a structure in which positive electrode current collector 7, positive electrode layer 20, solid electrolyte layer 40, negative electrode layer 30, and negative electrode current collector 8 are stacked in this order.

In positive electrode layer 20, conductive fibers 9 include conductive fiber aggregate 10 in which at least some of conductive fibers 9 are aggregated. That is, conductive fiber aggregate 10 includes at least a part of conductive fibers 9.

Positive electrode layer 20 in the present exemplary embodiment includes plate-like compressed body 11 containing conductive fiber aggregate 10 which is an aggregate of at least a part of solid electrolyte 1 and at least a part of conductive fibers 9 between particles of positive electrode active material 3. Compressed body 11 includes, for example, at least a part of solid electrolyte 1 and conductive fiber aggregate 10. Positive electrode layer 20 includes, for example, a plurality of compressed bodies 11. Furthermore, positive electrode layer 20 may include mixture 16 obtained by mixing single conductive fiber 9 not contained in conductive fiber aggregate 10, a part of solid electrolyte 1, and a part of solid electrolyte 2. Mixture 16 adheres to the surfaces of particles of positive electrode active material 3, for example.

In the present exemplary embodiment, solid electrolyte 1 is an example of the first solid electrolyte. Furthermore, solid electrolyte 2 is an example of the second solid electrolyte. Furthermore, solid electrolyte 5 is an example of the third solid electrolyte. Furthermore, solid electrolyte 6 is an example of the fourth solid electrolyte. For example, the same solid electrolyte material is used for solid electrolyte 1, solid electrolyte 2, solid electrolyte 5, and solid electrolyte 6, but a different solid electrolyte material may be used for at least one of these.

All-solid-state battery 100 in the present exemplary embodiment is produced, for example, by the following method. Positive electrode layer 20 formed on positive electrode current collector 7 made of a metal foil, negative electrode layer 30 formed on negative electrode current collector 8 made of a metal foil, and solid electrolyte layer 40 disposed between positive electrode layer 20 and negative electrode layer 30 are formed. Then, by pressing from the outer side of positive electrode current collector 7 and the outer side of negative electrode current collector 8 in the stacking direction, all-solid-state battery 100 is produced. The pressing pressure is, for example, 100 MPa or more and 1000 MPa or less. By pressing, a filling rate of at least one of solid electrolyte layer 40, positive electrode layer 20, and negative electrode layer 30 is set to 60% or more and less than 100%. By setting the filling rate to 60% or more, voids are reduced in solid electrolyte layer 40, positive electrode layer 20, or negative electrode layer 30, so that ion conduction and electron conduction are performed a lot, and good charge and discharge characteristics are obtained. Note that the filling rate is a proportion of a volume occupied by materials not including voids between materials to the total volume.

Note that the detail of the method of manufacturing all-solid-state battery 100 will be described later.

Pressed all-solid-state battery 100 is, for example, attached with a terminal and accommodated in a case. As the case for all-solid-state battery 100, for example, a stainless steel (SUS), iron, or aluminum case, a resin case, or an aluminum laminated bag is used.

Hereinafter, details of solid electrolyte layer 40, positive electrode layer 20, and negative electrode layer 30 of all-solid-state battery 100 in the present exemplary embodiment will be described.

### B. Solid Electrolyte Layer

First, solid electrolyte layer 40 will be described. Solid electrolyte layer 40 in the present exemplary embodiment contains solid electrolyte 6, and may further contain a binder.

### B-1. Solid Electrolyte

Solid electrolyte 6 in the present exemplary embodiment will be described. Examples of a solid electrolyte material used for solid electrolyte 6 include inorganic solid electrolytes such as sulfide-based solid electrolytes, halide-based solid electrolytes, and oxide-based solid electrolytes, which are general known materials. The solid electrolyte material has, for example, lithium ion conductivity. Any of the sulfide-based solid electrolyte, the halide-based solid electrolyte, and the oxide-based solid electrolyte may be used as the solid electrolyte material. The type of the sulfide-based solid electrolyte according to the present exemplary embodiment is not particularly limited. Examples of the sulfide-based solid electrolytes include Li₂S—SiS₂, LiI—Li₂S—SiS₂, LiI—Li₂S—P₂S₅, LiI—Li₂S—P₂O₅, LiI—Li₃PO₄—P₂S₅, and Li₂S—P₂S₅. In particular, the sulfide-based solid electrolyte may include Li, P, and S from the viewpoint of obtaining excellent lithium ion conductivity. Furthermore, the sulfide-based solid electrolyte may include P₂S₅ to have high reactivity with a binder and high bonding capability to a binder. Note that, the above description of “Li₂S—P₂S₅” means a sulfide-based solid electrolyte obtained by using a raw material composition containing Li₂S and P₂S₅, and the same applies to other descriptions.

In the present exemplary embodiment, the sulfide-based solid electrolyte material is, for example, a sulfide glass ceramic including Li₂S and P₂S₅, and a ratio of Li₂S to P₂S₅ may be in a range by mol from 70:30 to 80:20 or in a range from 75:25 to 80:20 for Li₂S:P₂S₅. The ratio of Li₂S to P₂S₅ in these ranges can produce a crystal structure having high lithium ion conductivity while keeping a high lithium (Li) concentration which influences battery characteristics. Furthermore, the ratio of Li₂S to P₂S₅ in these ranges also readily secures the amount of P₂S₅ that reacts with and bonds to the binder.

Solid electrolyte 6 is constituted by a plurality of particles. An average particle size of solid electrolyte 6 is, for example, smaller than an average particle size of positive electrode active material 3. This makes it easy to secure a contact area of positive electrode layer 20 with positive electrode active material 3.

Furthermore, the average particle size of solid electrolyte 6 is, for example, 0.2 μm or more and 10 μm or less. As a result, it is possible to suppress a decrease in lithium ion conductivity of entire solid electrolyte layer 40 by reducing the particle interface in solid electrolyte layer 40 and reducing the resistance component at the particle interface while securing the contact surface of positive electrode layer 20 with positive electrode active material 3.

Note that at least some of the plurality of particles constituting solid electrolyte 6 may form an aggregate by being subjected to compression and/or shearing.

### B-2. Binder

The binder according to the present exemplary embodiment will be described. The binder is an adhesive that does not have lithium ion conductivity and electron conductivity, and plays a role of bonding materials in solid electrolyte layer 40 to each other and solid electrolyte layer 40 to another layer. The binder in the present exemplary embodiment may contain a thermoplastic elastomer into which a functional group for improving adhesion strength is introduced, the functional group may be a carbonyl group, and from the viewpoint of improving adhesion strength, the carbonyl group may be maleic anhydride. The oxygen atom of the maleic anhydride reacts with solid electrolyte 6 to bond the particles of solid electrolyte 6 to each other via the binder, thereby forming a structure in which the binder is disposed between the particles of solid electrolyte 6 and the particles of solid electrolyte 6, and as a result, the adhesion strength is improved.

For example, styrene-butadiene-styrene (SBS), or styrene-ethylene-butadiene-styrene (SEBS) is used as a thermoplastic elastomer. This is because these materials have high bonding strength, and high durability also in cycle characteristics of a battery. As the thermoplastic elastomer, a hydrogenated (hereinafter, referred to as hydrogenation) thermoplastic elastomer may be used.

An addition amount of the binder in solid electrolyte layer 40 is, for example, 0.01 mass % or more and 5 mass % or less, may be 0.1 mass % or more and 3 mass % or less, or may be 0.1 mass % or more and 1 mass % or less. Adding the binder by 0.01 mass % or more readily causes bonding via the binder and thus sufficient bonding strength can be obtained. Furthermore, when the addition amount of the binder is 5 mass % or less, deterioration of battery performance such as charge and discharge characteristics is unlikely to occur, and further, for example, even if physical property values such as hardness, tensile strength, and tensile elongation of the binder change in a low temperature region, charge and discharge characteristics are unlikely to deteriorate.

### C. Positive Electrode Layer

Next, positive electrode layer 20 according to the present exemplary embodiment will be described. Positive electrode layer 20 in the present exemplary embodiment contains solid electrolyte 1, solid electrolyte 2, positive electrode active material 3, and conductive fibers 9. Moreover, a further non-fibrous conductive auxiliary agent such as acetylene black and KETJENBLACK (registered trademark) and a binder may be added to positive electrode layer 20 as necessary in order to secure the electron conductivity, but in a case where the addition amount is large, since the battery performance is affected, it is desirable that the amount is small to such an extent that the battery performance is not affected.

A weight ratio of positive electrode active material 3 to the total of solid electrolyte 1 and solid electrolyte 2 is, for example, in a range from 50:50 to 95:5, and may be in a range from 70:30 to 90:10.

Furthermore, a volume ratio of positive electrode active material 3 to the total of solid electrolyte 1 and solid electrolyte 2 is, for example, in a range from 60:40 to 90:10, and may be in a range from 70:30 to 85:15. This is because both the lithium ion conduction path and the electron conduction path in positive electrode layer 20 are easily secured by the volume ratio.

Positive electrode current collector 7 is made of, for example, a metal foil. For example, a metal foil of SUS, aluminum, nickel, titanium, or copper is used as the metal foil.

### C-1. Solid Electrolyte

Each of solid electrolyte materials used for solid electrolyte 1 and solid electrolyte 2 is arbitrarily selected from, for example, at least one or more of the solid electrolyte materials listed in [B-1. Solid electrolyte] described above. Solid electrolyte 1 and solid electrolyte 2 are, for example, the same solid electrolyte material. Solid electrolyte 1 and solid electrolyte 2 may be different solid electrolyte materials. Furthermore, although the selection of the material is not particularly limited, for example, a combination of the materials is selected within a range in which lithium ion conductivity is not significantly impaired at an interface where positive electrode active material 3 and solid electrolyte 1 are in contact with each other and an interface where solid electrolyte 1 and solid electrolyte 2, and solid electrolyte 6 are in contact with each other.

Each of solid electrolyte 1 and solid electrolyte 2 is constituted by, for example, a plurality of particles. Note that at least some of the plurality of particles constituting solid electrolyte 1 and solid electrolyte 2 may form an aggregate by being subjected to compression and shearing or compression or shearing.

### C-2. Binder

Since it is the same as the binder described above, it is omitted.

### C-3. Positive Electrode Active Material

Positive electrode active materials 3 according to the present exemplary embodiment will be described. For example, a lithium-containing transition metal oxide is used as a material of positive electrode active material 3 according to the present exemplary embodiment. Examples of the lithium-containing transition metal oxide include LiCoO₂, LiNiO₂, LiMn₂O₄, LiCoPO₄, LiNiPO₄, LiFePO₄, LiMnPO₄, compounds obtained by substituting transition metal of these compounds with one or two different elements, and the like. Known materials such as LiNi_{1/3}Co_{1/3}Mn_{1/3}O₂, LiNi_{0.8}Co_{0.15}Al_{0.05}O₂, and LiNi_{0.5}Mn_{1.5}O₂ are used as the compounds obtained by substituting the transition metal of the compounds with one or two different elements. One type or a combination of two or more types may be used as the material of positive electrode active material 3.

Furthermore, positive electrode active material 3 is constituted by a plurality of particles. Each particle of positive electrode active material 3 is a granulated particle in which a plurality of primary particles made of the above material are assembled. In the present specification, the granulated particles are referred to as particles of positive electrode active material 3. Here, a particle size of positive electrode active material 3 is not particularly limited, but for example, an average particle size of positive electrode active material 3 is 1 μm or more and 10 μm or less. Furthermore, a particle size distribution of positive electrode active material 3 is, for example, a distribution in which 80% or more of the entire particles are present within a particle size of ±40% with respect to the average particle size.

### C-4. Conductive Fiber

Conductive fiber 9 functions as a conductive auxiliary agent of positive electrode layer 20, and can enhance the electron conductivity in positive electrode layer 20. Conductive fiber 9 is constituted by a plurality of fibers. Conductive fiber 9 in the present exemplary embodiment is not particularly limited as long as it is a material that has conductivity, hardly reacts with positive electrode active material 3, solid electrolyte 1, and solid electrolyte 2, and can withstand a potential as a battery. From the viewpoint of the stability of the material during use of the battery, conductive fiber 9 is, for example, a carbon-based material. Specifically, the carbon-based material is a fibrous conductive carbon material. Examples of the carbon-based material include carbon nanotubes (CNT). Furthermore, as the carbon nanotubes, single-walled carbon nanotubes (SWCNT) or multi-walled carbon nanotubes (MWCNT) are used. Among these, multi-walled carbon nanotubes may be used as the carbon-based material from the viewpoint of cost and availability. On the other hand, since the multi-walled carbon nanotubes are hard fibers and are mixed from those having a large fiber diameter to those having a small fiber diameter, they are likely to exist as strongly entangled aggregates. Although details will be described later, according to the present exemplary embodiment, even in a case where conductive fibers 9 that are likely to exist as aggregates are used, the influence of the conductive fiber aggregates can be reduced, and a decrease in a battery capacity can be suppressed.

### D. Negative Electrode Layer

Next, negative electrode layer 30 according to the present exemplary embodiment will be described. Negative electrode layer 30 of the present exemplary embodiment includes solid electrolyte 5 and negative electrode active material 4. Moreover, a conductive auxiliary agent, such as acetylene black and KETJENBLACK, and a binder may be added to negative electrode layer 30 as necessary to secure electron conductivity, but in a case where the addition amount is large, since the battery performance is affected, it is desirable that the amount is small to such an extent that the battery performance is not affected. A ratio of solid electrolyte 5 to negative electrode active material 4 may be in a range from 5:95 to 60:40 and in a range from 30:70 to 50:50 in terms of weight. Furthermore, a volume ratio of negative electrode active material 4 to a total volume of negative electrode active material 4 and solid electrolyte 5 is, for example, 60% or more and 80% or less. With this volume ratio, both the lithium ion conduction path and the electron conduction path in negative electrode layer 30 are easily secured.

Negative electrode current collector 8 is made of, for example, a metal foil. For example, a metal foil of SUS, copper, and nickel is used as the metal foil.

### D-1. Solid Electrolyte

The solid electrolyte material used for solid electrolyte 5 is not particularly limited, and for example, at least one or more solid electrolyte materials listed in [B-1. Solid electrolyte] described above are arbitrarily selected. Solid electrolytes 5 are constituted by, for example, a plurality of particles. Note that at least some of the plurality of particles constituting solid electrolyte 5 may form an aggregate by being subjected to compression and shearing or compression or shearing.

### D-2. Binder

Since it is the same as the binder described above, it is omitted.

### D-3. Negative Electrode Active Material

Negative electrode active materials 4 according to the present exemplary embodiment will be described. As the material of negative electrode active material 4 in the present exemplary embodiment, for example, a metal easily alloyed with lithium such as lithium, indium, tin, or silicon, a carbon material such as hard carbon or graphite, or a known material such as Li₄Ti₅O₁₂ or SiOₓ is used.

Furthermore, negative electrode active materials 4 are constituted by, for example, a plurality of particles. A particle size of negative electrode active material 4 is not particularly limited. An average particle size of negative electrode active material 4 is, for example, 1 μm or more and 15 μm or less.

### <Method of Manufacturing All-Solid-State Battery>

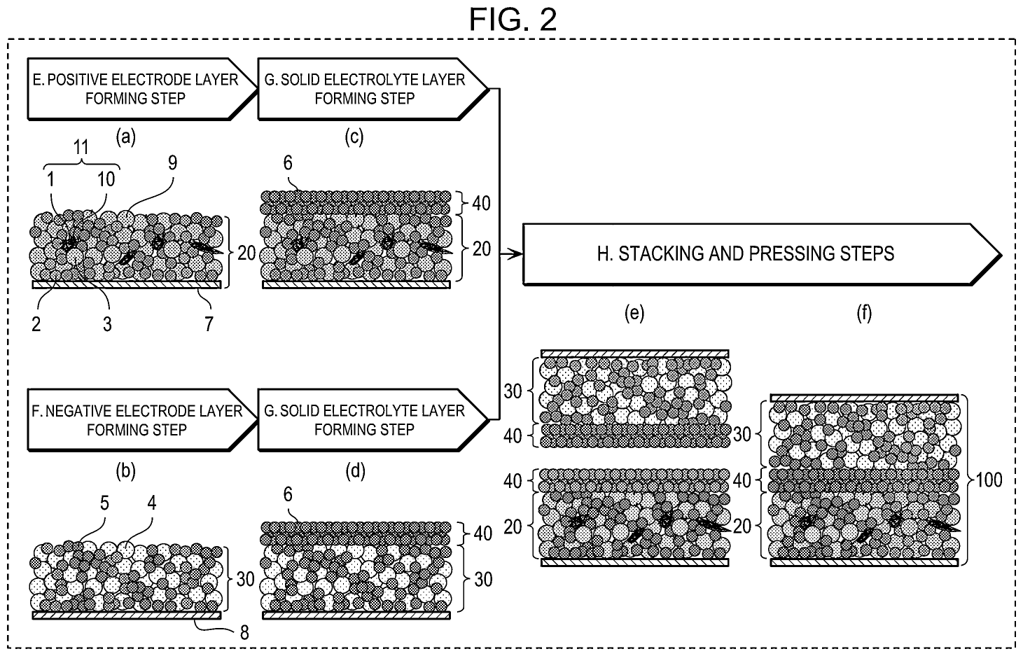

A method of manufacturing all-solid-state battery 100 according to the present exemplary embodiment will be described with reference to FIG. 2. Specifically, a method of manufacturing all-solid-state battery 100 having a structure in which positive electrode current collector 7, positive electrode layer 20, solid electrolyte layer 40, negative electrode layer 30, and negative electrode current collector 8 are stacked in this order will be described. FIG. 2 is a schematic cross-sectional view for explaining the method of manufacturing all-solid-state battery 100.

The method of manufacturing all-solid-state battery 100 includes, for example, a positive electrode layer film forming step, a negative electrode layer film forming step, a solid electrolyte layer film forming step, a stacking step, and a pressing step. In the positive electrode layer forming step (part (a) of FIG. 2), positive electrode layer 20 is formed on positive electrode current collector 7. In the negative electrode layer forming step (part (b) of FIG. 2), negative electrode layer 30 is formed on negative electrode current collector 8. In the solid electrolyte layer forming step (parts (c) and (d) of FIG. 2), solid electrolyte layer 40 is prepared. In the stacking step and the pressing step (parts (e) and (f) of FIG. 2), positive electrode layer 20 formed on positive electrode current collector 7, negative electrode layer 30 formed on negative electrode current collector 8, and prepared solid electrolyte layer 40 are stacked so that solid electrolyte layer 40 is disposed between positive electrode layer 20 and negative electrode layer 30 (stacking step), and pressed from the outside of positive electrode current collector 7 and negative electrode current collector 8 (pressing step). Hereinafter, details of each step will be described.

### E. Positive Electrode Layer Forming Step

In the film forming step (positive electrode layer forming step) of positive electrode layer 20 in the present exemplary embodiment, for example, the following method is performed.

The positive electrode layer forming step includes, for example, a mixture adjusting step, a powder stacking step, and a powder pressing step. In the mixture adjusting step, solid electrolyte 1, solid electrolyte 2, positive electrode active material 3, and conductive fibers 9 in a powder state, which do not contain a solvent, are prepared, and a binder and a further non-fibrous conductive auxiliary agent (not illustrated) are further prepared as necessary. Then, the prepared materials are stirred and mixed in a dry manner in a powder state while appropriate compressive force and shear force are applied to produce a positive electrode mixture in which positive electrode active material 3, solid electrolyte 1, solid electrolyte 2, and conductive fibers 9 are dispersed. At this time, some of the prepared materials are first stirred and mixed. In the powder stacking step, the obtained positive electrode mixture in a powder state is uniformly stacked on positive electrode current collector 7 to obtain a stacked body. In the powder pressing step, the stacked body obtained in the powder stacking step is pressed to form a film.

Furthermore, when the positive electrode mixture in a powder state is mixed by a method of stacking the positive electrode mixture, there is an advantage that a drying step is unnecessary and the manufacturing cost is reduced, and a solvent component contributing to the battery performance of all-solid-state battery 100 does not remain in positive electrode layer 20 after film formation, and there is an effect of suppressing deterioration of the battery performance. In a case where positive electrode layer 20 is manufactured in the form of stacking the positive electrode mixture in a powder state, for example, the solvent component contained in positive electrode layer 20 is 50 ppm or less, and positive electrode layer 20 does not substantially contain a solvent component. The concentration of the solvent component is a concentration on a weight basis. The solvent is, for example, an organic solvent such as heptane, xylene, or toluene.

Furthermore, it is important to pass through a step of stirring and mixing solid electrolyte 1 and conductive fibers 9 in a dry manner in the mixture adjusting step which is a preparation prior to the film forming step. Here, the stirring and mixing refers to a method of mixing solid electrolyte 1 and conductive fibers 9 while applying a compressive force and a shearing force when mixing solid electrolyte 1 and conductive fibers 9, and is not particularly limited thereto. Furthermore, the purpose of this stirring and mixing step is to form a mixture including compressed body 11 including at least a part of solid electrolyte 1 and conductive fiber aggregate 10 containing at least a part of conductive fibers 9. Here, compressed body 11 is a plate-like structure in which solid electrolyte 1 enters between the fibers of conductive fibers 9 constituting conductive fiber aggregate 10. Next, in the mixture adjusting step, the particles including positive electrode active material 3 and the particles including solid electrolyte 2 are put into a mixture obtained by stirring and mixing solid electrolyte 1 and conductive fibers 9, and further stirred and mixed to obtain a positive electrode mixture. A specific mixing procedure will be described later.

### F. Negative Electrode Layer Forming Step

The film forming step (negative electrode layer forming step) of negative electrode layer 30 in the present exemplary embodiment is the same as the film forming step of positive electrode layer 20 described in [E. Positive electrode layer forming step] above in the basic film forming method except that the material used is changed to that for negative electrode layer 30. Note that, in the negative electrode layer forming step, a negative electrode mixture may be manufactured using a solvent.

Negative electrode layer 30 is manufactured, for example, by a method in which solid electrolyte 5, negative electrode active material 4, and a binder and a conductive auxiliary agent (not illustrated) as necessary are mixed in a dry manner, and a negative electrode mixture in a powder state, which is not formed into a slurry, is stacked on negative electrode current collector 8 (similar to the method in [E. Positive electrode layer forming step] except that stirring and mixing in two steps is not performed). Furthermore, negative electrode layer 30 may be manufactured by a method in which a slurried negative electrode mixture containing a solvent is applied onto negative electrode current collector 8 and then dried.

Furthermore, in a case where the negative electrode layer is manufactured by a method of stacking the negative electrode mixture in a powder state, there is an advantage that a drying step is unnecessary and the manufacturing cost is reduced, and a solvent contributing to performance such as the capacity and durability of all-solid-state battery 100 does not remain in negative electrode layer 30 after film formation, and there is an effect of suppressing deterioration of battery performance. In a case where negative electrode layer 30 is manufactured in the form of stacking the negative electrode mixture in a powder state, for example, a solvent component contained in negative electrode layer 30 is 50 ppm or less, and negative electrode layer 30 does not substantially contain the solvent component. The concentration of the solvent component is a concentration on a weight basis.

### G. Solid Electrolyte Layer Forming Step

In solid electrolyte layer 40 in the present exemplary embodiment, for example, a slurry is produced by dispersing solid electrolyte 6 and, if necessary, a binder in a solvent, and the obtained slurry is applied onto positive electrode layer 20 and negative electrode layer 30 or positive electrode layer 20 or negative electrode layer 30 prepared above. Solid electrolyte layer 40 may be manufactured using a powdery material containing no solvent.

In the examples illustrated in parts (c) and (d) of FIG. 2, solid electrolyte layer 40 is formed on positive electrode layer 20 and negative electrode layer 30, but the present invention is not limited to these examples. Solid electrolyte layer 40 may be formed on either one of positive electrode layer 20 or negative electrode layer 30.

Alternatively, solid electrolyte layer 40 may be produced by the method described above on a base material such as a polyethylene terephthalate (PET) film, and obtained solid electrolyte layer 40 may be stacked on positive electrode layer 20 and negative electrode layer 30 or on positive electrode layer 20 or negative electrode layer 30.

### H. Stacking Step and Pressing Step

In the stacking step and the pressing step, positive electrode layer 20 formed on positive electrode current collector 7, negative electrode layer 30 formed on negative electrode current collector 8, and solid electrolyte layer 40 obtained in each film forming step are stacked such that solid electrolyte layer 40 is disposed between positive electrode layer 20 and negative electrode layer 30 (stacking step), and then pressing is performed from the outside of positive electrode current collector 7 and negative electrode current collector 8 (pressing step) to obtain all-solid-state battery 100.

The purpose of pressing is to increase densities of positive electrode layer 20, negative electrode layer 30, and solid electrolyte layer 40. By increasing the densities, lithium ion conductivity and electron conductivity can be improved in positive electrode layer 20, negative electrode layer 30, and solid electrolyte layer 40, and all-solid-state battery 100 having good battery performance is obtained.

### <Method of Manufacturing Positive Electrode Layer>

Hereinafter, detailed manufacturing method examples regarding positive electrode layer 20 of all-solid-state battery 100 according to the present exemplary embodiment will be described, but the present invention is not limited to these manufacturing method examples. Note that unless otherwise specified, each step is performed, for example, inside a glove box inside which the dew point is controlled to −45° C. or less or inside a dry room.

First, a material used for positive electrode layer 20 will be described. In the manufacturing of positive electrode layer 20, for example, a positive electrode mixture containing positive electrode active material 3, solid electrolyte 1, solid electrolyte 2, and conductive fibers 9 is used.

Positive electrode active material 3 is selected, for example, from the materials listed in the [C-3. Positive electrode active material] shown in the configuration of the all-solid-state battery in the present exemplary embodiment described above. Each of solid electrolyte 1 and solid electrolyte 2 is selected from, for example, the solid electrolyte materials listed in [B-1. Solid electrolyte]. Solid electrolyte 1 and solid electrolyte 2 may be the same material or different materials. Furthermore, conductive fibers 9 are selected from the materials listed in [C-4. Conductive fiber], for example.

Specific contents of the materials to be used will be further described. As positive electrode active material 3, for example, a material is used which has an average particle size of 1.0 μm and in which 80% or more of the particles of positive electrode active material 3 fall within a range of ±40% of the average particle size. Furthermore, for each of solid electrolyte 1 and solid electrolyte 2, for example, a particulate material having an average particle size of 0.1 μm or more and 1.0 μm or less is used. Furthermore, as conductive fibers 9, for example, multi-walled carbon nanotubes (MWCNT) having an average fiber diameter of 50 nm or more and 200 nm or less and a fiber length of 1 μm or more and 500 μm or less are used.

Furthermore, a total content of solid electrolyte 1 and solid electrolyte 2 in positive electrode layer 20 is appropriately selected so that a ratio with respect to a total content of positive electrode active material 3, solid electrolyte 1, and solid electrolyte 2 falls within a predetermined range. The ratio of the total content of solid electrolyte 1 and solid electrolyte 2 to the total content of positive electrode active material 3, solid electrolyte 1, and solid electrolyte 2 in positive electrode layer 20 is, for example, 10 vol % or more and 30 vol % or less, and may be 15 vol % or more and 30 vol % or less. Furthermore, the ratio of the total content of solid electrolyte 1 and solid electrolyte 2 to the total content of positive electrode active material 3, solid electrolyte 1, and solid electrolyte 2 is, for example, 10 wt % or more and 30 wt % or less. Furthermore, a ratio of the content of conductive fibers 9 to the total content of positive electrode active material 3, solid electrolyte 1, and solid electrolyte 2 is, for example, 0.1 vol % or more and 5 vol % or less. Furthermore, the ratio of the content of conductive fibers 9 to the total content of positive electrode active material 3, solid electrolyte 1, and solid electrolyte 2 is, for example, 0.05 wt % or more and 2 wt % or less.

Note that the ratio of the content of each material in positive electrode layer 20 is usually the same in the positive electrode mixture. Furthermore, in the present specification, vol %, which is a volume-based ratio, is a ratio based on the true volume.

It is important in the manufacturing of positive electrode layer 20 that plate-shaped compressed body 11 containing conductive fiber aggregate 10 in which at least a part of conductive fibers 9 is aggregated and at least a part of solid electrolyte 1 is present in positive electrode layer 20 finally formed through the mixture adjusting step, the powder stacking step, and the powder pressing step described above.

Detailed contents of a method of manufacturing positive electrode layer 20 such as a mixing procedure in production of the positive electrode mixture will be described below while comparing the exemplary embodiment with Comparative Example.

### (I) Method of Producing Positive Electrode Mixture in Exemplary Embodiment

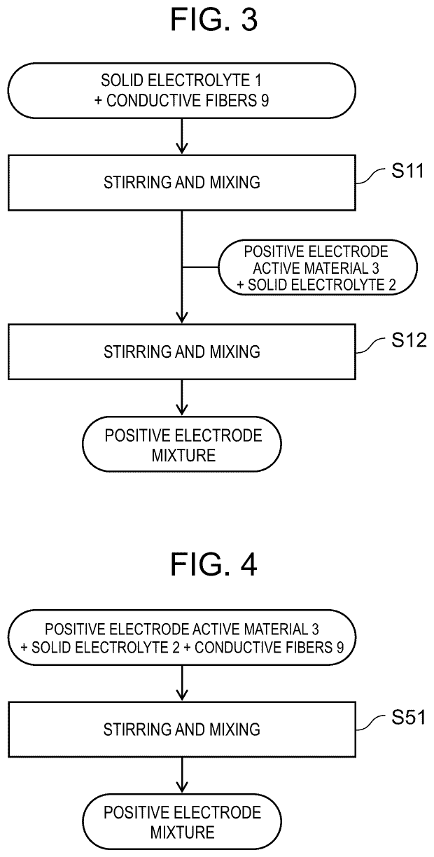

First, a method of producing the positive electrode mixture in the present exemplary embodiment will be described. FIG. 3 is a flowchart illustrating a method of producing the positive electrode mixture (mixture adjusting step) in the present exemplary embodiment.

First, solid electrolyte 1 and conductive fibers 9 are stirred and mixed in a dry manner to form a mixture including compressed body 11 including at least a part of solid electrolyte 1 and a conductive fiber aggregate containing at least a part of conductive fibers 9 (step S11). For example, solid electrolyte 1 and conductive fibers 9 are charged into a stirring and mixing device, and the charged materials are stirred and mixed while a compressive force and a shearing force are applied by the stirring and mixing device. As the stirring and mixing device, for example, a device provided with a rotary blade for stirring and mixing in a container into which a material is charged is used. Here, the stirring and mixing is mixing in which a compressive force and a shear force are applied to a material. For example, a predetermined space is provided between a container inner wall of the stirring and mixing device and the rotary blade, and the rotary blade rotates to apply the compressive force and the shearing force to the material in the space. The stirring and mixing is not limited to stirring and mixing using such a stirring and mixing device, and may be mixing in which a compressive force and a shearing force are applied to the material. By such stirring and mixing, the compressed body 11 including conductive fiber aggregate 10 containing at least a part of conductive fibers 9, and at least a part of solid electrolyte 1 is formed. The mixture formed by stirring and mixing solid electrolyte 1 and conductive fibers 9 in a dry manner includes, for example, compressed body 11, and remaining solid electrolyte 1 and conductive fibers 9 that do not constitute compressed body 11.

Here, compressed body 11 is described as follows. By applying a compressive force and a shearing force in a state where conductive fiber aggregate 10 and the particles of solid electrolyte 1 are mixed, conductive fiber aggregate 10 is stretched in a shearing direction, and at the same time, the particles of solid electrolyte 1 are pressed against stretched conductive fiber aggregate 10 while being deformed or pulverized. Therefore, deformation or pulverized particles of solid electrolyte 1 enter between the fibers while the fibers constituting conductive fiber aggregate 10 are spread, and a plate-shaped material is formed as a mixture of conductive fiber aggregate 10 and solid electrolyte 1. This plate-shaped material is compressed body 11.

Next, positive electrode active material 3 and solid electrolyte 2 are mixed with the mixture formed in step S11 by dry stirring and mixing (step S12). Thus, a positive electrode mixture is produced. Here, the contents of the process expressed as stirring and mixing are the same as those in step S11 described above. Note that, in step S12, it is sufficient that the mixture formed in step S11, positive electrode active material 3, and solid electrolyte 2 can be treated so as to be mixed as a whole, and mixing in which a compressive force and a shearing force are not substantially applied may be performed.

Then, positive electrode layer 20 is formed by, for example, the method described in [E. Positive electrode layer forming step] above using the produced positive electrode mixture. Furthermore, all-solid-state battery 100 is manufactured by the above-described method using positive electrode layer 20.

### (II) Method of Producing Positive Electrode Mixture in Comparative Example

Next, a method of producing the positive electrode mixture in Comparative Examples will be described. FIG. 4 is a flowchart illustrating the method of producing the positive electrode mixture (mixture adjusting step) in Comparative Example. In the method of producing the positive electrode mixture in Comparative Example, positive electrode active material 3, solid electrolyte 2, and conductive fibers 9 are stirred and mixed (step S51). In step S51, the same operation as in step S11 described above is performed except for the material to be used. The contents of the process expressed as stirring and mixing are the same as the description in step S11.

Next, a positive electrode layer is formed using the produced positive electrode mixture, for example, by the method explained in the above-described positive electrode layer forming step. Furthermore, an all-solid-state battery is manufactured by the above-described method using this positive electrode layer.

### (III) Behavior of Materials of Positive Electrode Mixture and Positive Electrode Layer

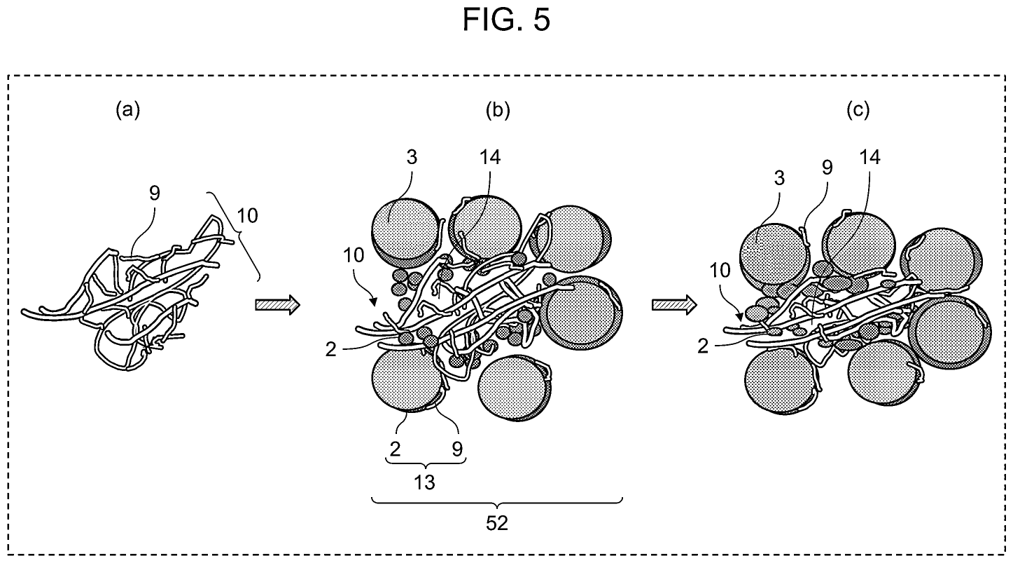

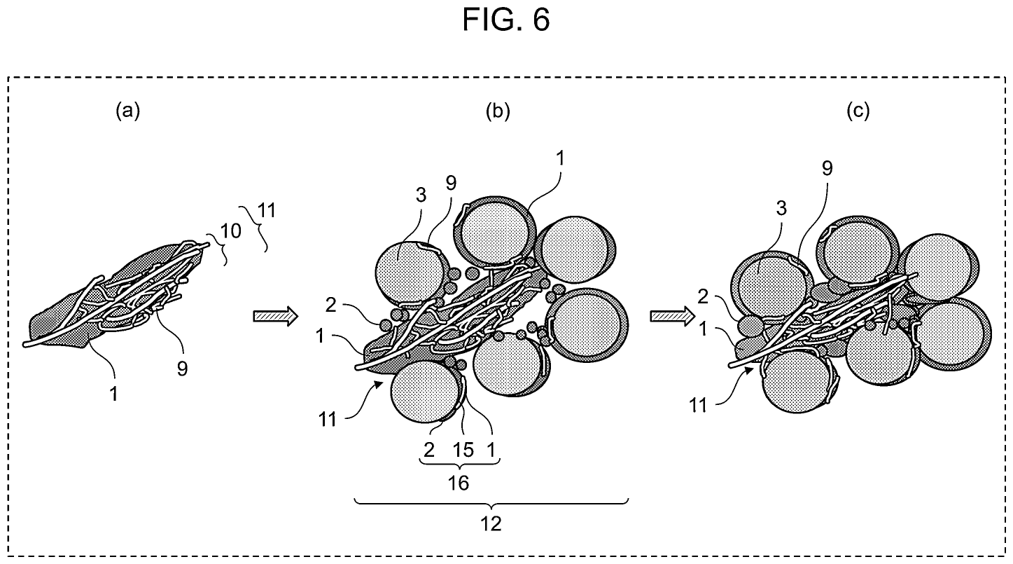

Here, the behavior of materials in positive electrode mixtures produced by the methods of producing a positive electrode mixture in the above-described exemplary embodiment and Comparative Example, and a positive electrode layer formed using the prepared positive electrode mixture will be described. Specifically, changes in the state of conductive fibers 9 including positive electrode active material 3, solid electrolyte 1, solid electrolyte 2, and conductive fiber aggregate 10 will be described in comparison with FIGS. 5 and 6.

FIG. 5 is a schematic view for explaining changes in states of positive electrode active material 3, solid electrolyte 2, and conductive fibers 9 in Comparative Example. FIG. 6 is a schematic view for explaining changes in states of positive electrode active material 3, solid electrolyte 1, solid electrolyte 2, and conductive fibers 9 in the exemplary embodiment.

Part (a) of FIG. 5 illustrates a state of conductive fiber aggregate 10 including at least a part of conductive fibers 9 before mixing positive electrode active material 3 and solid electrolyte 2 (that is, before step S51) in the method of producing the positive electrode mixture in Comparative Example. As illustrated in part (a) of FIG. 5, the conductive fiber aggregate 10 is a cotton-like aggregate in which fibers of the conductive fibers 9 having various fiber diameters and fiber lengths are entangled with each other to form a space inside.

On the other hand, part (a) of FIG. 6 illustrates a state of conductive fiber aggregate 10 after step S11 in the method of producing the positive electrode mixture according to the exemplary embodiment. As illustrated in part (a) of FIG. 6, in the method of producing the positive electrode mixture in the exemplary embodiment, plate-shaped compressed body 11 including conductive fiber aggregate 10 containing at least a part of conductive fibers 9, and at least a part of solid electrolyte 1 is formed before mixing positive electrode active material 3 and solid electrolyte 2 (that is, before step S12). Therefore, in conductive fiber aggregate 10 included in the compressed body 11, a part of solid electrolyte 1 enters inside, and conductive fiber aggregate 10 included in compressed body 11 and solid electrolyte 1 are integrated.

Next, part (b) of FIG. 5 illustrates a state of positive electrode mixture 52 obtained by stirring and mixing conductive fibers 9, positive electrode active material 3, and solid electrolyte 2 in the method of producing the positive electrode mixture in Comparative Example. As illustrated in part (b) of FIG. 5, in positive electrode mixture 52 in Comparative Example, a part of the surfaces of the particles of positive electrode active material 3 is covered with mixture 13 including a part of solid electrolyte 2 and fibers of single conductive fiber 9 that do not become conductive fiber aggregate 10. Furthermore, in positive electrode mixture 52, conductive fiber aggregate 10 in which conductive fibers 9 are partially aggregated is present in a state in which the particles of solid electrolyte 2 and the particles of positive electrode active material 3 adhere to the outside of conductive fiber aggregate 10 while maintaining the state in which space 14 is formed inside.

On the other hand, part (b) of FIG. 6 illustrates a state of positive electrode mixture 12 obtained through step S12 in the method of producing the positive electrode mixture in the exemplary embodiment. As illustrated in part (b) of FIG. 6, in positive electrode mixture 12 according to the exemplary embodiment, there is plate-shaped compressed body 11 in which a part of solid electrolyte 1 enters a space inside conductive fiber aggregate 10 and is compressed. Furthermore, in positive electrode mixture 12, compressed body 11 is present in a state where the particles of solid electrolyte 2 and the particles of positive electrode active material 3 are attached to the surface. Furthermore, mixture 16 including ground product 15 formed by crushing a part of compressed body 11 by stirring and mixing, a part of solid electrolyte 2, and a part of solid electrolyte 1 coats a part of the surfaces of the particles of positive electrode active material 3.

Next, part (c) of FIG. 5 illustrates a state in the positive electrode layer produced by pressing positive electrode mixture 52 obtained by the manufacturing method in Comparative Example. As illustrated in part (c) of FIG. 5, in the positive electrode layer in Comparative Example, space 14 existing in conductive fiber aggregate 10 at the stage of positive electrode mixture 52 remains. In the positive electrode layer in Comparative Example, remaining space 14 is reduced by pressing, but a connection portion by solid electrolyte 2 passing through the inside of conductive fiber aggregate 10 in a thickness direction of conductive fiber aggregate 10, that is, an ion conduction path is not formed.

On the other hand, part (c) of FIG. 6 illustrates a state in positive electrode layer 20 produced by pressing positive electrode mixture 12 obtained by the manufacturing method in the exemplary embodiment. As illustrated in part (c) of FIG. 6, in positive electrode layer 20 according to the exemplary embodiment, compressed body 11 in which a part of solid electrolyte 1 enters the space inside conductive fiber aggregate 10 is formed in advance, so that an ion conductive path passing through conductive fiber aggregate 10 in the thickness direction of conductive fiber aggregate 10 is formed. Therefore, in positive electrode layer 20 in the exemplary embodiment, since the ion conduction path is formed between the particles of positive electrode active material 3 existing around conductive fiber aggregate 10, positive electrode active material 3 can be effectively utilized. That is, even in a case where positive electrode layer 20 includes conductive fiber aggregate 10, it is possible to suppress a decrease in a battery capacity of all-solid-state battery 100.

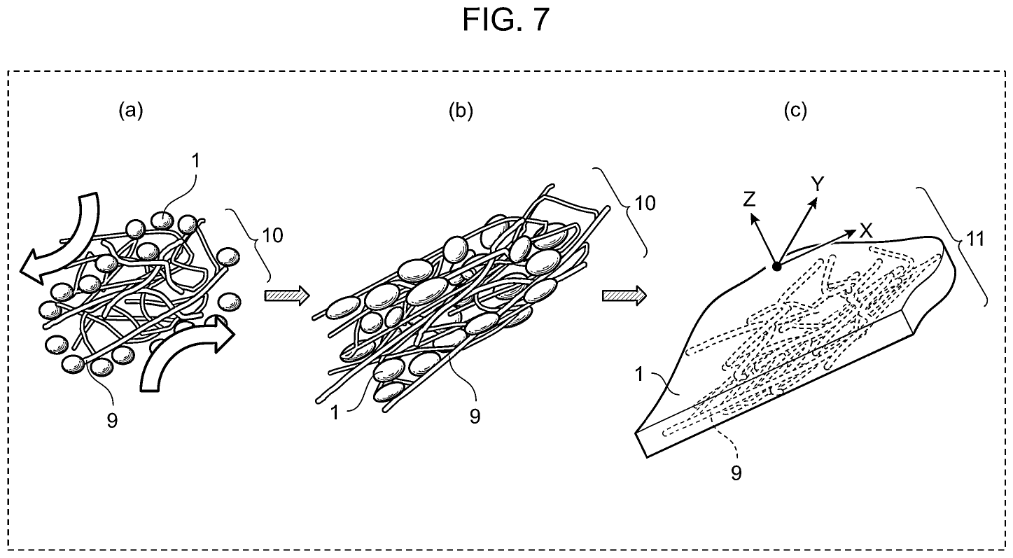

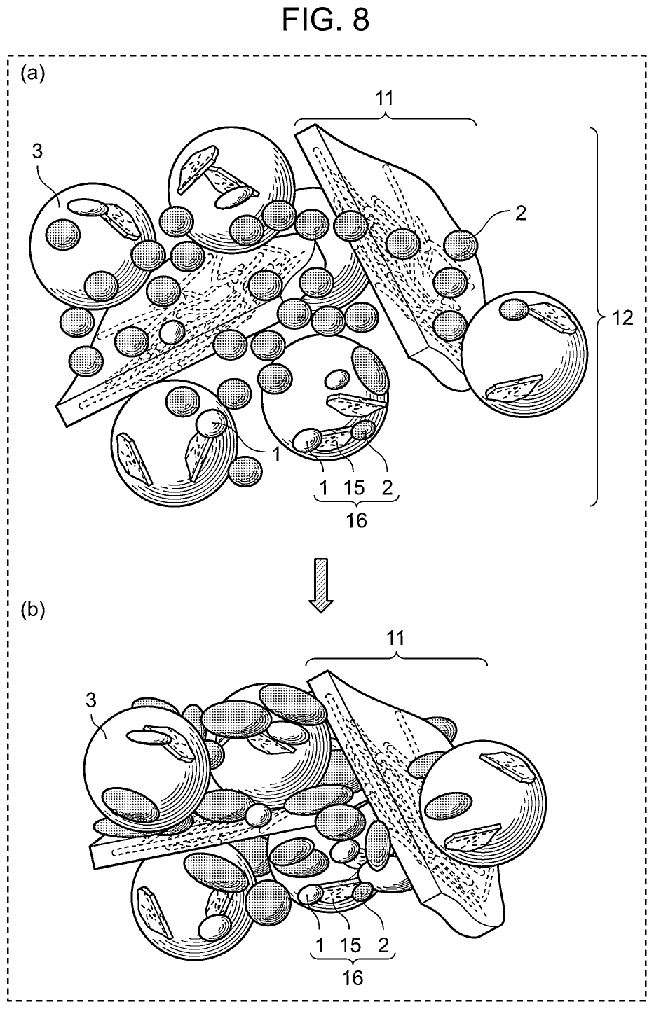

Here, in the above-described exemplary embodiment, a state of a process in which compressed body 11 is formed and positive electrode layer 20 including compressed body 11 is manufactured will be further described with reference to FIGS. 7 and 8. FIG. 7 is a schematic perspective view for explaining the behavior of the material in the process of forming compressed body 11 in the exemplary embodiment. FIG. 8 is a schematic perspective view for explaining the behavior of the material in the process of manufacturing positive electrode mixture 12 and positive electrode layer 20 in the exemplary embodiment.

Part (a) of FIG. 7 illustrates a state of the material at the initial stage of the process in step S11 described above. As illustrated in part (a) of FIG. 7, at the initial stage of stirring and mixing in step S11, conductive fiber aggregate 10 and solid electrolyte 1 are kneaded while a compressive force and a shearing force indicated by white arrows in part (a) of FIG. 7 are applied. At that time, the compressive force and a force due to the shearing force are transmitted to conductive fiber aggregate 10 through the particles of solid electrolyte 1, the fibers of conductive fibers 9 constituting conductive fiber aggregate 10 are expanded, a space between the fibers of conductive fiber aggregate 10 is expanded, and the particles of solid electrolyte 1 are pushed into the space. Furthermore, the particles of solid electrolyte 1 are pulverized by stirring and mixing, and solid electrolyte 1 further turned into fine particles is pushed into the space. As described above, the space between the fibers of conductive fiber aggregate 10 is widened by stirring and mixing, and the particles and fine particles of solid electrolyte 1 are repeatedly pushed into the space, so that a state in which solid electrolyte 1 enters the space inside conductive fiber aggregate 10 is formed as illustrated in part (b) of FIG. 7. By further applying the compressive force and the shearing force to the state illustrated in part (b) of FIG. 7, as illustrated in part (c) of FIG. 7, the particles of solid electrolyte 1 and the fine particles of solid electrolyte 1 obtained by pulverizing the particles are fixed to each other, and plate-shaped compressed body 11 is formed.

Here, in the stirring and mixing in step S11 described above, a volume of solid electrolyte 1 to be added is, for example, 3 times or more and 10 times or less a volume of conductive fibers 9 to be added. When a relationship of the volumes is 3 times or more, the fibers of conductive fibers 9 constituting conductive fiber aggregate 10 described above can be easily expanded stably. Furthermore, when the relationship of the volumes is 10 times or less, the interference between solid electrolytes 1 is suppressed, the compressive force and the shearing force are easily transmitted to conductive fiber aggregate 10, and the fibers of conductive fibers 9 constituting conductive fiber aggregate 10 can be easily expanded stably. Therefore, when the relationship of the volumes is 3 times or more and 10 times or less, it is easy to stably form compressed body 11. Furthermore, solid electrolyte 1 may be stirred and mixed with conductive fibers 9 in a plurality of times, for example, by adding solid electrolyte 1 little by little.

Moreover, positive electrode active material 3 and solid electrolyte 2 are further added to the mixture including compressed body 11 illustrated in part (c) of FIG. 7 as in step S12 described above, and stirred and mixed. Thereby, as illustrated in part (a) of FIG. 8, positive electrode mixture 12 in a state where compressed body 11, ground product 15 obtained by pulverizing a part of compressed body 11, solid electrolyte 1 and conductive fibers 9 which partially remain without constituting compressed body 11 in the process illustrated in parts (a) to (c) of FIG. 7, the deformed particles of newly added solid electrolyte 2, and mixture 16 are attached to the surfaces of the particles of positive electrode active material 3 is produced on the surfaces of the particles of positive electrode active material 3.

When positive electrode layer 20 is formed using positive electrode mixture 12 illustrated in part (a) of FIG. 8, compressed body 11 is sandwiched between the particles of positive electrode active material 3 as illustrated in part (b) of FIG. 8. Furthermore, ground product 15, solid electrolyte 1, conductive fibers 9, and solid electrolyte 2 are filled between the particles of positive electrode active material 3 and compressed body 11, between the particles of positive electrode active material 3, and between compressed bodies 11, and positive electrode layer 20 having a predetermined filling rate is formed. Therefore, uniform and stable positive electrode layer 20 is formed.

As described above, by manufacturing positive electrode layer 20 by the manufacturing method in the present exemplary embodiment described above, compressed body 11 enters between the particles of positive electrode active material 3, and the ion conduction path is formed between the particles of positive electrode active material 3. Therefore, even in a case where positive electrode layer 20 includes conductive fibers 9, a decrease in the battery capacity can be suppressed.

Furthermore, as a general film forming method in a wet manner, there is a method in which a solvent and a material constituting a positive electrode mixture are mixed, and a dispersant is added as necessary. In this case, it may be possible to easily disentangle and disperse conductive fiber aggregate 10 formed by entangling the fibers of conductive fibers 9 by selecting a dispersant and setting process conditions. However, when positive electrode layer 20 is manufactured by a film forming method in a dry manner without using a solvent as in the manufacturing method in the present exemplary embodiment, it is particularly difficult and important to handle conductive fiber aggregate 10. By using the manufacturing method in the present exemplary embodiment described above, the influence of conductive fiber aggregate 10 on the battery capacity can be effectively reduced, and the decrease in the battery capacity can be suppressed. Therefore, the present exemplary embodiment is considered to have particularly effective contents in a case where the residual solvent component in positive electrode layer 20 constituting all-solid-state battery 100 is 50 ppm or less as a feature of positive electrode layer 20 formed by the film forming method in a dry manner.

As illustrated in part (c) of FIG. 7, the thickness direction of plate-shaped compressed body 11 is defined as a Z-axis direction, and directions orthogonal to the thickness direction of compressed body 11 and orthogonal to each other are defined as an X-axis direction and a Y-axis direction. The X-axis direction and the Y-axis direction are also plane directions in which conductive fiber aggregate 10 is expanded. The X-axis direction is an example of the first direction, and the Y-axis direction is an example of the second direction. The X-axis direction is, for example, a direction of a long axis in which a linear distance between two points connecting the contour of compressed body 11 is longest in a case where compressed body 11 is viewed along the Z-axis direction.

In the present exemplary embodiment, at least one of a maximum length (hereinafter, referred to as a first maximum length) of compressed body 11 in the X-axis direction and a maximum length (hereinafter, referred to as a second maximum length) of compressed body 11 in the Y-axis direction is, for example, 5 times or more and 50 times or less an average thickness (average length in the Z-axis direction) of compressed body 11. Furthermore, both the first maximum length and the second maximum length may be 5 times or more and 50 times or less the average thickness of compressed body 11. In compressed body 11, ion conductivity in the thickness direction (Z-axis direction) tends to be higher than ion conductivity in the X-axis direction and the Y-axis direction of compressed body 11. Therefore, when a relationship of the lengths is 5 times or more, an aspect ratio of compressed body 11 increases, and it becomes difficult to arrange the particles of positive electrode active material 3 close to each other such that the particles of positive electrode active material 3 are in the X-axis direction or the Y-axis direction of compressed body 11, so that a distance between the particles of positive electrode active material 3 is less likely to increase, the ion conductivity between the particles of positive electrode active material 3 is less likely to decrease, and deterioration of battery performance can be suppressed. Furthermore, since the relationship of the lengths is 50 times or less, in the process of manufacturing positive electrode layer 20, filling property of positive electrode active material 3 in positive electrode layer 20 by compressed body 11 is hardly reduced, and deterioration of battery performance can be suppressed.

Furthermore, at least one of the first maximum length and the second maximum length is, for example, twice or more the average particle size of positive electrode active material 3. Furthermore, both the first maximum length and the second maximum length may be twice or more the average particle size of positive electrode active material 3. Even when conductive fiber 9 including large conductive fiber aggregate 10 in which a relationship between the maximum length and the particle size is twice or more is used, the decrease in the battery capacity can be suppressed by forming compressed body 11.

Furthermore, the average thickness (length in the Z-axis direction) of compressed body 11 is, for example, in a range of 2 times or more and 50 times or less the average fiber diameter of conductive fiber aggregates 10 constituting compressed body 11. When a relationship between the average thickness and the fiber diameter is 2 times or more, the fibers of the conductive fiber aggregates 10 are hardly densely clogged in the thickness direction of compressed body 11, a part of solid electrolyte 1 easily enters the space of conductive fiber aggregates 10 in compressed body 11, and the ionic conductivity in the thickness direction of compressed body 11 is easily secured. Furthermore, since the relationship between the average thickness and the fiber diameter is 50 times or less, a distance of ion conduction in compressed body 11 is unlikely to increase, and deterioration of battery performance can be suppressed.

The shape and size of compressed body 11 as described above can be adjusted by, for example, stirring and mixing conditions, the fiber diameter and fiber length of conductive fibers 9, and the material properties of solid electrolyte 1.

Furthermore, conductive fiber aggregate 10 constituting compressed body 11 includes, for example, a portion having a fiber diameter of 50 nm or more. As a result, in compressed body 11, since the fibers are thicker than a predetermined value, the inside of conductive fiber aggregate 10 is less likely to be clogged with the fibers, and spacing between the fibers of conductive fiber aggregate 10 is three-dimensionally secured. As a result, a part of solid electrolyte 1 easily enters between the fibers of conductive fiber aggregate 10, and ion conductivity in compressed body 11 is improved, so that deterioration of battery performance can be suppressed.

Furthermore, as described above, the ratio of the total content of solid electrolyte 1 and solid electrolyte 2 to the total content of positive electrode active material 3, solid electrolyte 1, and solid electrolyte 2 in positive electrode layer 20 is, for example, 10 vol % or more and 30 vol % or less. When the ratio is 30% vol or less, an amount of positive electrode active material 3 in positive electrode layer 20 is secured, the battery capacity is easily improved, and compressed body 11 is effectively easily disposed between the particles of positive electrode active material 3. Furthermore, when the ratio is 10 vol % or more, an ion conduction path is easily secured.

### EXAMPLES

Next, results of evaluating the battery performance of the all-solid-state battery in the present disclosure will be described in examples, but the present disclosure is not limited to only examples. Specifically, all-solid-state batteries in Example 1 and Comparative Example 1 were produced, and the battery characteristics of the produced all-solid-state batteries were evaluated.

### Production of All-Solid-State Battery

(I) Example 1

Positive electrode layer 20 was formed using positive electrode mixture 12 produced by the method described in “(I) Method of producing positive electrode mixture in exemplary embodiment” described above. At this time, the ratio of the total content of solid electrolyte 1 and solid electrolyte 2 to the total content of positive electrode active material 3, solid electrolyte 1 and solid electrolyte 2 in positive electrode layer 20 was 15 vol %. Furthermore, the addition amount of conductive fibers 9 in step S11 was 1.0 vol % with respect to the total amount of positive electrode active material 3, solid electrolyte 1, and solid electrolyte 2 in positive electrode layer 20.

Then, all-solid-state battery 100 in Example 1 was manufactured through the negative electrode layer forming step, the solid electrolyte layer forming step, the stacking step, and the pressing step described in <Method of manufacturing all-solid-state battery> above.

### (II) Comparative Example 1

An all-solid-state battery in Comparative Example 1 was manufactured in the same manner as in the all-solid-state battery in Example 1 described above, except that a positive electrode layer was formed using a positive electrode mixture produced by the method described in “(II) Method of producing positive electrode mixture in Comparative Example” described above. At this time, the ratio of the content of solid electrolyte 2 to the total content of positive electrode active material 3 and solid electrolyte 2 in the positive electrode layer was 15 vol %. Furthermore, the addition amount of conductive fibers 9 in step S51 was 1.0 vol % with respect to the total amount of positive electrode active material 3 and solid electrolyte 2 in the positive electrode layer.

### Evaluation of Battery Capacity

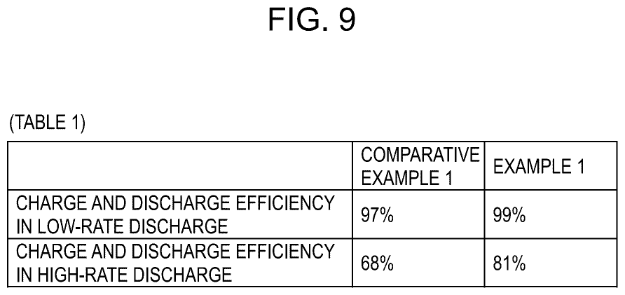

Next, the battery characteristics of the all-solid-state batteries according to Example 1 and Comparative Example 1 produced above were evaluated. Specifically, Table 1 in FIG. 9 illustrates results of evaluating the charge and discharge efficiency as the battery characteristics as an index of the battery capacity. The charge and discharge efficiency was evaluated under two conditions of low-rate discharge and high-rate discharge. Furthermore, in the evaluation of the charge and discharge efficiency, charge was performed under the condition of a final voltage of 3.7 V, a current rate of 0.05 C, and a temperature of 25° C. Furthermore, discharge was performed under the conditions of a final voltage of 1.9 V, a current rate of 0.05 C in the case of low-rate discharge, a current rate of 1 C in the case of high-rate discharge, and 25° C. Furthermore, in the evaluation of the charge and discharge efficiency, charge was first conducted, and a ratio (%) of the discharge capacity to the charge capacity was calculated as the charge and discharge efficiency.

As illustrated in Table 1 of FIG. 9, it can be seen that the all-solid-state battery in Example 1 has higher charge and discharge efficiency than the all-solid-state battery in Comparative Example 1. In particular, the all-solid-state battery in Example 1 suppressed the reduction in the charge and discharge efficiency in the high-rate discharge.

This is considered to be due to the effect of ensuring the ion conduction path and effectively utilizing positive electrode active material 3 by suppressing the reduction of the ion conduction path due to conductive fiber aggregate 10 by forming compressed body 11 in the positive electrode layer as described above.

### Other Exemplary Embodiments

While the all-solid-state battery according to the present disclosure has been described above based on the exemplary embodiment, the present disclosure is not limited to the above-described exemplary embodiment. Exemplary embodiments that are various modifications of the exemplary embodiment conceivable by those skilled in the art, and another exemplary embodiment constructed by combining some constituent elements in the exemplary embodiment are also included in the scope of the present disclosure without departing from the gist of the present disclosure.

For example, in the above exemplary embodiment, an example in which conducting ions in all-solid-state battery 100 are lithium ions has been described, but the present disclosure is not limited thereto. The ions conducting in all-solid-state battery 100 may be ions other than lithium ions, such as sodium ions, magnesium ions, potassium ions, calcium ions, or copper ions.

### INDUSTRIAL APPLICABILITY

The all-solid-state battery according to the present disclosure is expected to be applied to various batteries such as a power supply for mobile electronic devices and an in-vehicle battery.

### REFERENCE MARKS IN THE DRAWINGS

1, 2, 5, 6: solid electrolyte
3: positive electrode active material
4: negative electrode active material
7: positive electrode current collector
8: negative electrode current collector
9: conductive fiber
10: conductive fiber aggregate
11: compressed body
12, 52: positive electrode mixture
13, 16: mixture
14: space
15: ground product
20: positive electrode layer
30: negative electrode layer
40: solid electrolyte layer
100: all-solid-state battery

1. An all-solid-state battery comprising:
a positive electrode current collector;
a positive electrode layer including positive electrode active materials, a first solid electrolyte, a second solid electrolyte, and a conductive fiber;
a solid electrolyte layer including a fourth solid electrolyte;
a negative electrode layer including a negative electrode active material and a third solid electrolyte; and
a negative electrode current collector,
all of which are stacked in this order,
wherein
the positive electrode layer includes a solvent component of 50 ppm or less,
the positive electrode layer includes a plate-shaped compressed body between the positive electrode active materials, the plate-shaped compressed body including at least a part of the first solid electrolyte and at least a part of the conductive fiber, and
the compressed body has a first maximum length in a first direction orthogonal to a thickness direction of the compressed body and a second maximum length in a second direction orthogonal to the thickness direction of the compressed body and the first direction, at least one of the first maximum length and the second maximum length being 5 times or more and 50 times or less an average thickness of the compressed body.

2. The all-solid-state battery according to claim 1, wherein the first maximum length and the second maximum length are 5 times or more and 50 times or less the average thickness of the compressed body.

3. The all-solid-state battery according to claim 2, wherein at least one of the first maximum length and the second maximum length is twice or more an average particle size of each of the positive electrode active materials.

4. The all-solid-state battery according to claim 1, wherein at least one of the first maximum length and the second maximum length is twice or more an average particle size of each of the positive electrode active materials.

5. The all-solid-state battery according to claim 1, wherein the conductive fiber included in the compressed body includes a portion having a fiber diameter of 50 nm or more.

6. The all-solid-state battery according to claim 1, wherein the average thickness of the compressed body is in a range of 2 times or more and 50 times or less an average fiber diameter of the conductive fiber included in the compressed body.

7. The all-solid-state battery according to claim 1, wherein the conductive fiber includes a carbon-based material.

8. The all-solid-state battery according to claim 1, wherein in the positive electrode layer, the first solid electrolyte and the second solid electrolyte has a total content having a ratio of 15 vol % or more and 30 vol % or less with respect to a total content of the positive electrode active materials, the first solid electrolyte, and the second solid electrolyte.

9. The all-solid-state battery according to claim 1, wherein in the positive electrode layer, the conductive fiber has a content having a ratio of 0.1 vol % or more and 5 vol % or less with respect to a total content of the positive electrode active materials, the first solid electrolyte, and the second solid electrolyte.

10. A method of manufacturing an all-solid-state battery including
a positive electrode current collector,
a positive electrode layer including a positive electrode active material, a first solid electrolyte, a second solid electrolyte, and a conductive fiber,
a solid electrolyte layer including a fourth solid electrolyte,
a negative electrode layer including a negative electrode active material and a third solid electrolyte, and
a negative electrode current collector,
all of which are stacked in this order,
the method comprising a step of manufacturing the positive electrode layer,
wherein the step of manufacturing the positive electrode layer includes:
a step of mixing the first solid electrolyte and the conductive fiber in a dry manner and forming a mixture including a compressed body including at least a part of the first solid electrolyte and an aggregate containing at least a part of the conductive fiber; and
a step of mixing the positive electrode active material and the second solid electrolyte with the formed mixture.

11. The method according to claim 10, wherein in the step of forming a mixture, the first solid electrolyte has a volume of 3 times or more and 10 times or less a volume of the conductive fiber.
